(19) United States
(12) Patent Application Publication
(10) Pub. No.: US 2020/0039860 A1
(43) Pub. Date: Feb. 6, 2020

(54) THERMAL TREATMENT OF PROPPANTS COMPRISING GLASS MATERIAL

(71) Applicant: BORAL IP HOLDINGS (AUSTRALIA) PTY LIMITED, North Sydney (AU)

(72) Inventors: Louise Margaret KEYTE, Wollongong (AU); Camille HOLT, Bradbury (AU); Redmond Richard LLOYD, Wollongong (AU)

(73) Assignee: BORAL IP HOLDINGS (AUSTRALIA) PTY LIMITED, North Sydney (AU)

(21) Appl. No.: 16/337,749

(22) PCT Filed: Sep. 29, 2016
(86) PCT No.: PCT/IB2016/001421

§ 371 Date: Mar. 28, 2019

(51) Int. Cl. C03B 19/10; C03B 32/02; C09K 8/80

(52) U.S. Cl. CPC C03B 19/1005; C03B 19/1095; C03C 1/002; C09K 8/80; C03C 2203/52; C03B 32/02

(57) ABSTRACT

Proppants and methods for their preparation are described herein. The proppants can be prepared by a process comprising (a) directing the molten slag material at a temperature above 1300° C. to an atomizing apparatus to output the molten slag material in the form of atomized droplets, (b) projecting the droplets of the molten slag material, wherein a substantial portion of the droplets at least partially solidifies in flight, (c) maintaining the at least partially solidified droplets at a temperature between 700° C. and 1300° C. to provide proppant particles having a crystalline phase; and (d) cooling the proppant particles to below 700° C. Methods for hydraulic fracturing of a well in a subterranean formation having a fracturing stress are also described herein.

### FIELD OF THE DISCLOSURE

This disclosure relates generally to proppants, more particularly, to methods of making proppants using thermal treatment.

### BACKGROUND OF THE DISCLOSURE

In the process of acquiring oil and/or gas from a well, it is often necessary to stimulate the flow of hydrocarbons via hydraulic fracturing. Unless the pressure is maintained, however, the newly formed openings close. In order to hold the fracture open once the fracturing pressure is released, a propping agent (proppant) is mixed with the fluid and injected into the opening. With down well pressures often greater than 5000 pounds per square inch, the proppants must exhibit suitable strength, reliability and permeability. Typically, proppants are manufactured from materials such as kaolin and bauxite in a rotary kiln. The material, however, must be mined, grounded, pelletized, heated, and sized before use. Consequently, the manufacturing process requires high energy input and is therefore very expensive. There is a need for a low energy, cost effective process for producing proppants with desirable properties for resisting down well pressures. The compositions and methods described herein address these and other needs.

### SUMMARY OF THE DISCLOSURE

Proppants (proppant particles) and methods for their preparation are described herein. The proppants described herein comprise a crystalline phase. In some embodiments, the proppants comprise from greater than 0% to 90%, such as from 30% to 90% by weight, of a crystalline phase. The presence of the crystalline phase in the proppants can provide a more favorable failure mechanism, compared to proppants that do not include the crystalline phase. For example, the Type I failure of the proppants can be at least 10% greater, for example, at least 25% greater, than the Type I failure of proppants that do not include a crystalline phase. In some cases, when the proppants are subjected to the crush test described by ISO 13503-2: 2006/API RO19C:2008, at least 50% of the resulting particles by weight have a diameter of 35% or greater (e.g., 50% or greater) of the original proppant diameter. For example, wherein the proppants have an average diameter of from 850 μm to 1 mm and when the proppants are subjected to the crush test described by ISO 13503-2: 2006/API RO19C:2008, at least 50% of the resulting particles by weight have a diameter of greater than 300 μm (e.g., greater than 425 μm). In some cases, the proppants may also exhibit improved strength, toughness, resistance to chemical attack from acids and aqueous salt solutions, Vickers indentation fracture resistance (VIFR), and/or crush resistance, compared to proppants that do not include the crystalline phase

The proppants described herein can be prepared from a molten slag material. The molten slag material can include blast furnace slag, steelmaking slag, copper furnace slag, ladle furnace slag, nickel furnace slag, or mixtures thereof. In some embodiments, the molten slag material comprises a material selected from aluminum oxide, barium oxide, boron oxide, calcium oxide, chromium oxide, iron oxide, magnesium oxide, manganese oxide, phosphorous oxide, potassium oxide, silicon oxide, sodium oxide, sulfur oxide, strontium oxide, titanium oxide, vanadium oxide, zirconium oxide, mixtures thereof, and compounds thereof. The molten slag can include one or more additives. The one or more additives can include aluminum, beryllium, boron, calcium, carbon, chromium, iron, lithium, magnesium, manganese, nitrogen, oxygen, phosphorous, potassium, silicon, sodium, sulfur, titanium, yttrium (III) oxide, zirconium, aluminum dross, volcanic ash, and mixtures thereof. In some examples, the molten slag material includes a nucleating agent. The nucleating agent can include titanium, zirconium, barium, aluminum, strontium, vanadium, phosphorus, fluorine, or combinations thereof. In some embodiments, the nucleating agent includes titanium, barium, or combinations thereof.

The method for preparing the proppants can include (a) directing the molten slag material at a temperature above 1300° C. to an atomizing apparatus to output the molten slag material in the form of atomized droplets. The method can further include (b) projecting the droplets of the molten slag material, wherein a substantial portion of the droplets at least partially solidify in flight. The at least partially solidified droplets can have a solid fraction volume of from 20% to 100% by volume, such as from 20% to 80% or from 20% to 60% by volume. In some embodiments, the droplets are partially solidified. In some embodiments, the droplets are completely solidified. The at least partially solidified droplets are not cooled to ambient temperature through quenching, for example, by using an external cooling apparatus, during the method for preparing the proppants.

The method for preparing the proppants can include (c) maintaining the at least partially solidified droplets at a temperature between 700° C. and 1300° C. for between 5 minutes to 10 hours to provide proppants having a crystalline phase. In some embodiments, the at least partially solidified droplets are maintained at temperatures between 700° C. and 1100° C.

The method for preparing the proppants can include (d) cooling the proppants to below 700° C. and (e) collecting the proppants. In certain embodiments, the method can include heating the proppants to between 700° C. and 1300° C., such as between 700° C. and 1100° C., and then cooling the proppants to below 700° C. to be collected. For example, the proppants can be heated from a temperature of less than 700° C. (e.g., from 100° C. to less than 700° C.) to between 700° C. to 1300° C. The cycle of cooling below 700° C. and heating to between 700° C. and 1300° C. can be repeated once or more than once (e.g., two or more times).

In some examples, proppants can be prepared by a process comprising (a) directing the molten slag material at a temperature above 1300° C. to an atomizing apparatus to output the molten slag material in the form of atomized droplets, (b) projecting the droplets of the molten slag material, wherein a substantial portion of the droplets at least partially solidify in flight, (c) maintaining the at least partially solidified droplets at a temperature between 700° C. and 1300° C. to provide proppants having a crystalline phase; (d) cooling the proppants to below 700° C.; and (e) collecting the proppants.

Methods for hydraulic fracturing of a well in a subterranean formation having a fracturing stress are also described herein. The method can include pumping a fracturing fluid comprising the proppants disclosed herein into the well at a pressure above the fracturing stress of the formation to carry the proppants in the fluid into the subterranean formation.

### DETAILED DESCRIPTION

Proppants, i.e., proppant particles, and methods for their preparation are described herein. As described herein, the proppants have a microstructure that includes a crystalline phase. In some embodiments, the crystalline phase is embedded in an amorphous phase. The presence of the crystalline phase in the proppants can provide improved strength, toughness, resistance to chemical attack from acids and aqueous salt solutions, Vickers indentation fracture resistance (VIFR), and/or crush resistance, as well as a more favorable failure mechanism, compared to proppants that do not include the crystalline phase.

The proppants can include greater than 0% by weight (based on the weight of the proppants) of a crystalline phase. For example, the proppants can include 5% or greater, 10% or greater, 15% or greater, 20% or greater, 25% or greater, 30% or greater, 35% or greater, 40% or greater, 45% or greater, 50% or greater, 55% or greater, 60% or greater, 65% or greater, 70% or greater, 75% or greater, 80% or greater, or 85% or greater by weight (based on the weight of the proppants) of a crystalline phase. In some embodiments, the proppants can include 90% or less, 85% or less, 80% or less, 75% or less, 70% or less, 65% or less, 60% or less, 55% or less, 50% or less, 45% or less, 40% or less, or 35% or less by weight (based on the weight of the proppants) of a crystalline phase. In certain embodiments, the proppants can include from greater than 0% to 90%, from 30% to 90%, from 35% to 80%, or from 40% to 60% by weight (based on the weight of the proppants) of a crystalline phase. The amount of the crystalline phase as well as the various morphologies of the crystalline phases can be determined by quantitative x-ray diffraction (QXRD) and backscattered electron microscopy (BSEM), respectively.

As described herein, the disclosed proppants exhibit a more favorable failure mechanism, compared to proppants that do not include a crystalline phase. In particular, the failure mechanism of the proppants under compressive loading will tend to fail into fewer, and larger fragments, referred to herein as “Type I” failure, compared to proppants that do not include a crystalline phase which will tend to fail into a multitude of fine particulates under compressive loading, referred to herein as “Type II” failure. The “Type I” and “Type II” failure mechanisms can be determined by the amount of fine and coarse fragments produced when the proppants are subjected to the crush test, as described by ISO 13503-2: 2006/API RO19C:2008. A method for determining Type I and Type II failures of proppants is described herein.

In some cases, the Type I failure of the proppants described herein is increased relative to the Type I failure of proppants that do not include a crystalline phase. In some embodiments, when the proppants are subjected to the crush test described by ISO 13503-2: 2006/API RO19C:2008, at least 50% of the resulting particles (fragments) by weight have a diameter of 35% or greater (e.g., 50% or greater) of the original proppants. In some embodiments, at least 55%, at least 60%, at least 65%, at least 70%, at least 75%, at least 80%, at least 85%, at least 90%, at least 95%, or up to 100% of the resulting particles by weight have a diameter of 35% or greater (e.g., 40% or greater, 45% or greater, 50% or greater, 55% or greater, 60% or greater, 65% or greater, 70% or greater, 75% or greater, 80% or greater, 85% or greater, 90% or greater, 95% or greater, or up to 100%) of the original proppant diameter, when the proppants are subjected to the crush test as described by ISO 13503-2: 2006/API RO19C:2008.

For example, the proppants when having an average starting diameter of from 850 μm to 1 mm, when subjected to the crush test as described by ISO 13503-2: 2006/API RO19C:2008, comprise particles (fragments), wherein at least 50% of the particles by weight have a diameter of greater than 300 μm (e.g., greater than 425 μm). In some embodiments, the proppants can comprise particles (fragments), wherein at least 55%, at least 60%, at least 65%, at least 70%, at least 75%, at least 80%, at least 85%, at least 90%, at least 95%, or up to 100% of the particles by weight have a diameter of greater than 300 μm (e.g., greater than 350 μm, greater than 400 μm, greater than 425 μm, greater than 450 μm, greater than 475 μm, greater than 500 μm, greater than 525 μm, greater than 550 μm, greater than 575 μm, greater than 600 μm, or greater than 650 μm), when subjected to the crush test as described by ISO 13503-2: 2006/API RO19C:2008. Thus, the proppant particles described herein are less likely to shatter when subjected to the crush test and advantageously will often break into halves as is consistent with Type I failure than into multiple fragments as is consistent with Type II failure.

Various commercial grades of proppants are known in the art. In some aspects, the proppant particle size may determine their performance in meeting downhole conditions and completion designs. Therefore, a proppant selection factor is their particle size. The particle size of the proppants can be measured in mesh size ranges within which 90% of the proppants fall within the mesh size. Disclosed herein are proppants having a mesh size of 16/20 mesh (particle diameter ranges from 850-1200 μm), 20/40 mesh (particle diameter ranges from 425-850 μm), 30/50 mesh (particle diameter ranges from 300-600 μm), 40/70 mesh (particle diameter ranges from 212-425 μm), or 70/140 mesh (particle diameter ranges from 100-212 μm). Accordingly, the proppants, having any one of the starting diameters disclosed herein, when subjected to the crush test as described by ISO 13503-2: 2006/API RO19C:2008, comprise particles (fragments), wherein at least 50% of the particles by weight have a diameter of 35% or greater (e.g., 40% or greater, 45% or greater, 50% or greater, 55% or greater, 60% or greater, 65% or greater, 70% or greater, 75% or greater, 80% or greater, 85% or greater, 90% or greater, 95% or greater, or up to 100%) of the original proppant diameter.

In some embodiments, the Type I failure of the proppants can be at least 10%, such as at least 15%, at least 20%, or at least 25% greater than the Type I failure of proppants that do not include a crystalline phase. In some embodiments, the ratio of Type I failure to Type II failure of the proppants is at least 10%, such as at least 15%, at least 20%, or at least 25% greater than the ratio of Type I failure to Type II failure for proppants that do not include a crystalline phase.

The proppants described herein are mechanically strong. The proppants may have a crush strength of 1,000 psi or higher, such as from 1,000 psi to 20,000 psi, from 1,500 psi to 10,000 psi, or from 3,000 psi to 10,000 psi. The proppants may also exhibit an improved fracture toughness compared to the fracture toughness of proppants that do not include a crystalline phase. In some embodiments, the proppants can have a fracture toughness at least 10%, such as at least 15%, at least 20%, or at least 25% greater than the fracture toughness of proppants that do not include a crystalline phase.

The proppants described herein may also exhibit an improved Vickers indentation fracture resistance (VIFR) compared to the VIFR of proppants that do not include a crystalline phase. The VIFR is a measure of resistance to crack growth in the presence of first the stress field applied by the indenting object, and second the residual stress field caused by the plastic deformation of an indent. In some embodiments, the proppants may have a VIFR that is at least 10%, such as at least 15%, at least 20%, or at least 25% greater than the VIFR of proppants that do not include a crystalline phase. Cesari, F. et al. (Ceramics International, 2006, 32:249-255) describes how to determine the VIFR.

The proppants may also exhibit an improved acid resistance compared to the acid resistance of proppants that do not include a crystalline phase. For example, the proppants can have an acid resistance at least 10%, such as at least 15%, at least 20%, or at least 25% greater than the acid resistance of proppants that do not include a crystalline phase.

The proppants can be spherical or irregularly shaped. In some embodiments, the proppants can be spherical, oval, or any spheroidal shape. For example, the proppants can have a Krumbein shape factor, that is, a sphericity and roundness of 0.5 or greater, such as from 0.5 to 1, such as 0.7 to 0.9 or 0.7 to 0.8. The Krumbein shape factor of the proppants can be determined using ISO 13503-2:2006 or API RP19C:2008.

The proppants may be of any suitable size. In some embodiments, the proppants can have an average diameter of 0.3 mm or greater, such as from 0.3 mm to 3 mm, from 0.3 mm to 2 mm, or from 0.3 mm to 1 mm. In some embodiments, 80% or greater by number of the proppants can have an average particle diameter of 3 mm or less, such as from 0.3 to 3 mm.

The proppants can have a density of 1.0 g/cm³ or greater. For example, the proppants can have a density of from 1.0 g/cm³ to 4.0 g/cm³, such as from 2.0 g/cm³ to 3.5 g/cm³ or from 2.5 g/cm³ to 3.0 g/cm³.

Methods for preparing proppants are described herein. The proppants can be prepared from a glass material. The glass material can be any material formed from an inorganic compound containing a metal, semi-metal, non-metal, or combinations thereof. In some embodiments, the glass material can comprise a natural glass material such as a meltable rock including basalt, granite, marble, andesite, syenite, or combinations thereof. In some examples, the glass material can be any conventional glass such as, for example, soda-lime glass, lead glass, or borosilicate glass.

In some embodiments, the glass material can be derived from a molten glass material such as from a by-product from the process of smelting an ore to purify metals, also known as slag. The slag can be from any metal refining vessel including blast furnace slag, iron furnace slag, steelmaking slag, copper furnace slag, ladle furnace slag, nickel furnace slag, or mixtures thereof. In some embodiments, the molten glass material comprises a material selected from aluminum oxide, barium oxide, boron oxide, calcium oxide, chromium oxide, iron oxide, magnesium oxide, manganese oxide, phosphorous oxide, potassium oxide, silicon oxide, sodium oxide, sulfur oxide, strontium oxide, titanium oxide, vanadium oxide, zirconium oxide, mixtures thereof, and compounds thereof.

The glass material, such as slag material can include one or more additives. The additives can include a material derived from aluminum, barium, beryllium, boron, calcium, carbon, chromium, fluorine, iron, lithium, magnesium, manganese, nitrogen, oxygen, phosphorous, potassium, silicon, sodium, sulfur, titanium, yttrium (III) oxide, zirconium, aluminum dross, volcanic ash, and mixtures thereof. In some cases, the one or more additives can include an alkali metal oxide, an alkaline metal oxide, a transition metal oxide, and combinations thereof. In some examples, the one or more additives can include a slag material. For example, the proppants can include a material having a high silicon content such as an additional slag material, other than the slag material used as the major component in the proppants. In other words, the proppants can be made by a mixture of two different types of slag material.

The one or more additives in the glass material can include a nucleating agent. The nucleating agent can include titanium, zirconium, barium, aluminum, strontium, vanadium, phosphorous, fluorine, or combinations thereof. In some examples, the nucleating agent can include titanium (e.g., a titanium oxide compound), barium (e.g., a barium oxide compound), zirconium (e.g., a zirconium oxide compound), or a combination thereof. In some embodiments, the nucleating agent includes titanium dioxide.

The one or more additives can be present in the molten glass material in an amount of from 0.1% to 25% by weight, such as 0.1% to 10%, or 0.1% to 5% by weight.

In some embodiments, the proppants described herein are prepared from a molten slag material. Thus the method for preparing the proppants can include (a) directing the molten slag material to an atomizing apparatus to output the molten slag material in the form of atomized droplets. The molten slag material can be directed to the atomizing apparatus by any suitable means, such as via a conduit. In some examples, the molten slag material can be directed to the atomizing apparatus by a tube, pipe, channel, trough, or other form of conduit. The molten slag material may be discharged from the conduit by any suitable means known in the art. In some examples, the molten slag material may be discharged by a nozzle, spout, tap, or other means of controlling the delivery of the molten slag material to the atomizing apparatus. In some embodiments, the molten slag material may be discharged from the end of the conduit without any other means of controlling the delivery.

In some embodiments, the slag material may be provided as a solid, for example, a meltable rock. In these embodiments, the method can include heating the solid slag material to its molten state prior to directing the molten slag material on to the atomizing apparatus.

The molten slag material can be at an elevated temperature in the conduit, prior to contacting the atomizing apparatus. For example, the molten slag material can be at an elevated temperature wherein the slag material is substantially molten. In some examples, the molten slag material can be at a temperature of from 1200° C. to 1600° C. In some examples, the molten slag material can be at a temperature of at least 1300° C. In some embodiments, the temperature of the molten slag material in the conduit may be higher than the temperature at the time the material is received by the atomizing apparatus due to heat loss between the end of the conduit and the atomizing apparatus. It will be understood by those of skill in the art that the temperature at which the glass material is substantially molten is dependent on the nature of the slag material.

The flow rate (also referred to as a tapping rate) of the molten slag material from the conduit and on to the atomizing apparatus may vary. For example, the flow rate may depend on the design and operating conditions of other components used in the method, for example, the atomizing apparatus to output the molten slag material in the form of atomized droplets, and on the glass material being atomized. In some embodiments, the flow rate of the molten glass material from the conduit can be from 1 kg/min, for example in small plants or test rigs, to several tons/min, for example in an industrial scale plants.

The atomizing apparatus to output the molten slag material in the form of atomized droplets can be any suitable atomizing apparatus. In some embodiments, the atomizing apparatus can be a rotary spinning disc such as a rotary atomizer. Suitable rotary apparatus are described in WO2009/155667 to Xie et al.

The rotary atomizer, on contact with the molten slag material, forces the slag material outward where it is granulated. The rotating speed of the rotary apparatus can influence the diameter and shape of the molten slag droplets. It is believed that higher rotating speeds made the droplets smaller, more spherical, and uniform. The rotary apparatus can be operated at any suitable speed for forming any desirable atomized droplets from the molten slag material. In some embodiments, the speed of the rotary apparatus can be from 500 rpm to 20,000 rpm or 900 rpm to 10,000 rpm (e.g., 900 rpm to 2500 rpm). In some examples, droplets with an average diameter of 5 mm or greater can be obtained at a rotating speed of less than 1500 rpm. In some examples, droplets with an average diameter of 2 mm or less can be obtained at a rotating speed of 1500 rpm or greater. The exit velocity of the droplet can also influence the droplet size and shape. The person skilled in the art would understand how to select the rotating speed of the rotary apparatus to obtain desired droplet size and shape.

The method for preparing proppants can include (b) projecting the droplets of the molten slag material, for example, towards a receiver. In some embodiments, the atomizing apparatus projects the molten slag material towards the receiver. As the droplets project towards the receiver, the droplets may cool by releasing heat energy, such that a substantial portion of the droplets at least partially solidifies in flight. As used herein, “at least partially solidified” droplets refers to particles of completely solidified glass material and/or particles having at least a solidified outer shell, and may also have a molten inner core.

The at least partially solidified droplets can have a solid fraction volume of 20% or greater. For example the at least partially solidified droplets can have a solid fraction volume of 30% or greater, 50% or greater, or 60% or greater. In some examples, the at least partially solidified droplets can have a solid fraction volume of from 20% to 100%, from 20% to 80% or from 20% to 60%. In some examples, the at least partially solidified droplets can have a solid fraction volume of up to 100%. The person skilled in the art would understand that the extent of the at least partial solidification of the droplets can depend on the droplet flight time, temperature, droplet size, and/or velocity of the droplet. For example, it is understood that smaller droplets (for example, 2 mm or smaller) can reach a higher solid fraction compared to larger droplets (3 mm or greater), before contact with the receiver. In some examples, droplets 2 mm or smaller may have a solid fraction volume of 80% or greater. In some examples, droplets greater than 2 mm may have a solid fraction volume of less than 50%. The viscosity and surface tension of the droplets may also affect the solid fraction volume. In some embodiments, the partially solidified droplets can have a solidified outer region or shell and a molten inner region or core. One of ordinary skill in the art would know how to modify the various parameters for controlling the solid fraction volume, depending on the desired proppant properties is required.

In some embodiments, droplets having a solid fraction of 50% or greater can be in an amount of 60% or greater. For example, droplets having a solid fraction of 50% or greater can be in an amount of 70% or greater, 80% or greater, 85% or greater, 90% or greater, 92% or greater, 94% or greater, 95% or greater, 96% or greater, 97% or greater, 98% or greater, 99% or greater, or 100%.

In some embodiments, the droplets may be projected towards a target surface where the droplets impact the target surface prior to the receiver. The target surface may be positioned at a distance and angle such that a substantial portion of the droplets have not become fully solidified prior to impact. Impact of the partially solidified droplets with the target surface may cause at least a portion of the partially solidified droplets to fracture and form fractured droplets. The fracturing of the partially solidified droplets may cause the solidified outer region to crack, break, rupture, or otherwise fracture and expose at least a portion of molten inner region to the exterior of the fractured droplets. The exposure of the molten inner region to the exterior may allow the fractured droplets to cool and solidify faster than the partially solidified droplets would have in the absence of fracturing on impact with the target surface. The angle at which the target surface is disposed relative to the trajectory of the droplets may also be modified to control the force of the impact. WO 2009/155666 to Xie et al. discloses a granulator comprising a rotary atomizer for receiving a molten material and projecting droplets of the molten material there from; and an impact surface disposed within the trajectory of the droplets and upon which the droplets impact.

The at least partially solidified droplets can be any suitable size. The droplets can be substantially the same size as the proppants described herein, particularly where the droplets are not fractured as part of the process. In some embodiments, the partially solidified droplets can have an average diameter of 0.3 mm or greater. In some examples, the at least partially solidified droplets can have an average diameter from 0.3 mm to 3 mm, such as from 0.3 mm to 2 mm, 0.3 mm to 1 mm, 0.3 mm to 0.9 mm, or 0.3 mm to 0.85 mm. In some embodiments, 75% or greater, 80% or greater, 85% or greater, 90% or greater, or 95% or greater by number of the droplets can have an average particle diameter of 3 mm or less. For example, 75% or greater, 80% or greater, 85% or greater, 90% or greater, or 95% or greater by number of the droplets can have an average particle diameter of 0.3 to 3 mm.

The droplet flight time (time spent between the atomizing apparatus and the receiver) may vary. The droplet flight time can influence the amount and the solid fraction volume of the partially solidified droplets. It is believed that longer flight times increase the solid fraction volume of the partially solidified droplets. However, a person skilled in the art would understand that the nature of the molten glass material, the temperature of the glass material, and the droplet size will influence the solid fraction volume. In some embodiments, the droplet flight time between the atomizing apparatus and the receiver can be 5 seconds or less. For example, the droplet flight time between the rotary atomizer and the receiver can be 1 second or less; 0.75 seconds or less, 0.5 seconds or less, or 0.3 seconds or less.

Even though some cooling of the at least partially solidified droplets may take place between the atomizing apparatus and the receiver, the at least partially solidified droplets are maintained at a temperature above 700° C. to introduce a crystalline phase into the proppants. For example, the method can include (c) maintaining the at least partially solidified droplets at a temperature between 700° C. and 1300° C. to provide proppants having a crystalline phase. In some embodiments, the at least partially solidified droplets can be maintained between 700° C. and 1300° C. for between 5 minutes and 25 hours, such as between 5 minutes and 10 hours. In some embodiments, the at least partially solidified droplets can be maintained between 700° C. and 1300° C. for at least 5 minutes, at least 10 minutes, at least 15 minutes, at least 20 minutes, at least 45 minutes, at least 1 hour, at least 1.5 hours, or at least 2 hours. In some embodiments, the crystalline phases can be formed by maintaining the at least partially solidified droplets at temperatures between 700° C. and 1100° C.

Without wishing to be bound by theory, it is believed that formation of the crystalline phase initiates in the core of the proppant particles and continues to form outward from the core. Particularly, as the droplets are projected in flight, the droplets begin to cool and solidify from the exterior surface in. Accordingly, the core temperature of the droplets is higher and, in some cases, the core may be molten, compared to the exterior portion of the droplets. During this time and while the droplets are maintained at a temperature of from 700° C. to 1300° C., the formation of the crystalline phase (which involves rearrangement of the component atoms into a more highly ordered crystalline form) begins in the core and continues outward from the core. In this regard, the crystalline phase of the proppants is embedded in the amorphous phase. In contrast, if the entire droplet is cooled to below 700° C. (e.g., to room temperature) and then heated to a temperature above 700° C., it is believed that the exterior portion of the crystalline phase becomes molten prior to the core and the formation of the crystalline phase initiates from the exterior of the proppants.

In some aspects, maintaining the at least partially solidified droplets at a temperature between 700° C. and 1300° C. can include heating the at least partially solidified droplets from a temperature of less than 700° C. (e.g., 100° C. to less than 700° C., or from 400° C. to less than 700° C.) to a temperature between 700° C. and 1300° C., such as between 700° C. and 1100° C. As mentioned above, doing so can toughen the proppant particles, for example, by increasing the crystallinity of the outer portion of the proppant particles. For example, the at least partially solidified droplets can be heated at a temperature between 700° C. and 1300° C., such as between 700° C. and 1100° C. for between 5 minutes and 10 hours. The cycle of cooling below 700° C. and heating to between 700° C. and 1300° C. can be repeated once or more than once (e.g., two or more times) to provide the desired crystallinity and/or toughness.

The temperature profile (i.e. heating and cooling rate and holding time at given temperatures between 700° C. and 1300° C.) can be varied to control the properties of the proppants. Different holding temperatures and heating or cooling rates can provide different microstructure to the particles. The term “microstructure,” as used herein refers to the amount, size, location and type of crystalline phases present. Adjusting the temperature profile is believed to control the relative rates of crystal nucleation and growth in the glass, which in turn can affect the type, size and amount of crystalline phases formed. Controlling cooling rates can also introduce or alleviate stress buildup from differential thermal expansion in the particles. This can impact the strength of the proppants formed and is believed to change the durability of the surface of the particles. One of ordinary skill can determine the period of time and rate of heating/cooling the at least partially solidified droplets. The atmosphere in which the nucleation and heat treatment may affect the nucleating phase morphology and/or growth rate of the crystalline phase. Thus, the method can include controlling the atmosphere around the droplets. The temperature ranges for crystallization can be estimated using differential thermal analysis (DTA) as well as based on the knowledge of one skilled in the art.

Once the proppants are formed and have the desired crystallinity and/or toughness, the method can include (d) cooling the proppants to below 700° C. In some embodiments, the proppants can be blasted with a gas and/or a liquid, to recover the heat energy released from the proppants. In some embodiments, the proppants can be blasted with air, a reactant gas, and/or water. In some examples, the proppants can be blasted with air.

The method can further include (e) collecting the proppants, such as in a receiver. As discussed herein, the at least partially solidified droplets can be projected to a receiver. All or substantially all of the projected droplets of molten glass material may follow the trajectory towards the receiver. Any receiver known in the art may be used for the collection of the at least partially solidified droplets. In some examples, the receiver can be an opening of any dimensions positioned such that the at least partially solidified droplets are collected from flight.

The proppants described herein can be used to prop open subterranean formations. In some embodiments, the proppants can be suspended in a liquid phase or other medium to facilitate transporting the proppant down a well to a subterranean formation and placed such as to allow the flow of hydrocarbons, natural gas, or other raw materials out of the formation. In some embodiments, the present disclosure relates to a fracturing fluid containing one or more of the proppants described herein. In some embodiments, the present disclosure relates to a well site or subterranean formation containing one or more of the proppants described herein. The proppants can withstand a broad range of temperatures from 200° C. to 1500° C.

The medium for pumping the proppant can be any desired medium capable of transporting the proppants to its desired location. For example, the medium can be an aqueous-based medium or an oil-based medium. In some examples, the medium can be selected from water, brine solutions, aqueous polymer solutions, aqueous surfactant solutions, viscous emulsions of water and oil, gelled oils, gelled aqueous fluids, foams, gases, or combinations thereof.

Methods for hydraulic fracturing of a well in a subterranean formation having a fracturing stress are also described herein. The method can include introducing a fracturing fluid comprising the proppants described herein into the well such as by pumping or other means of introduction known in the art. The proppants can be introduced at a pressure above the fracturing stress of the formation to carry the proppants in the fluid into the subterranean formation.

### EXAMPLES

### Determination of the Proportion of Type I and Type II Failure.

A method for determining the proportion of Type I failure to Type II failure is provided below.
1. Perform crush test as described in ISO 13503-2: 2006/API RO19C:2008.
2. Collect fines from crush test using a sieve having a size such that the smallest particle(s) in the sample do(es) not pass though the sieve.
3. Pass fines through three (3) sieves to differentiate between failure mechanisms:
   a. A sieve with mesh size approximately 50% that of the sieve used in step 2.
   b. A sieve with mesh size approximately 66% that of the sieve used in step 3a.
   c. A sieve with mesh size approximately 33% that of the sieve used in step 3a.
4. Collect and weigh the fragments obtained from step 2 and steps 3a-3c.

The greater the amount of material obtained from steps 2 and 3a (i.e., the two largest size fractions), the greater the amount of the sample which underwent a favorable (Type II) failure mechanism.

Determination of the Proportion of Type I and Type II Failure in Proppant Particles (not Made According to this Disclosure).

As an example, the proportion of fines were determined in two samples comprising −1 mm, +850 μm glass beads. The first sample included the untreated glass beads and the second sample included glass beads treated by heating to induce a crystalline phase. The sieve used in step 2 (above) is an 850 μm sieve. The three sieves used in step 3 (above) were 425 μm, 300 μm, and 150 μm sieves.

For the first sample, the analysis of fines from the crush test according to ISO 13503-2: 2006/API RO19C:2008 is as follows:

+425 μm: 38.9% by weight
−425, +300 μm: 15.0% by weight
−300, +150 μm: 21.1% by weight
−150 μm: 23.3% by weight

For the second sample, the analysis of fines from the crush test according to ISO 13503-2: 2006/API RO19C:2008 is as follows:

+425 μm: 56.3% by weight
−425, +300 μm: 13.9% by weight
−300, +150 μm: 15.6% by weight
−150 μm: 13.6% by weight
The treated glass beads had a greater amount of fragments having a size of >300 um after crushing and therefore show a greater percentage of the sample undergoing a favorable failure mechanism.

The compositions and methods of the appended claims are not limited in scope by the specific compositions and methods described herein, which are intended as illustrations of a few aspects of the claims and any compositions and methods that are functionally equivalent are intended to fall within the scope of the claims. Various modifications of the compositions and methods in addition to those shown and described herein are intended to fall within the scope of the appended claims. Further, while only certain representative materials and method steps disclosed herein are specifically described, other combinations of the materials and method steps also are intended to fall within the scope of the appended claims, even if not specifically recited. Thus, a combination of steps, elements, components, or constituents may be explicitly mentioned herein; however, other combinations of steps, elements, components, and constituents are included, even though not explicitly stated. The term “comprising” and variations thereof as used herein is used synonymously with the term “including” and variations thereof and are open, non-limiting terms. Although the terms “comprising” and “including” have been used herein to describe various embodiments, the terms “consisting essentially of” and “consisting of” can be used in place of “comprising” and “including” to provide for more specific embodiments and are also disclosed. As used in this disclosure and in the appended claims, the singular forms “a”, “an”, “the”, include plural referents unless the context clearly dictates otherwise.

1. A method of forming proppant particles from a molten slag material, the method comprising:
(a) directing the molten slag material at a temperature above 1300° C. to an atomizing apparatus to output the molten slag material in the form of atomized droplets,
(b) projecting the droplets of the molten slag material, wherein a substantial portion of the droplets at least partially solidifies in flight,
(c) maintaining the at least partially solidified droplets at a temperature between 700° C. and 1300° C. for between 5 minutes to 10 hours to provide proppant particles having a crystalline phase;
(d) cooling the proppant particles to below 700° C.; and
(e) collecting the proppant particles.

2. The method of claim 1, wherein the method includes maintaining the at least partially solidified droplets at temperatures between 700° C. and 1100° C.

3. The method of claim 1, wherein the method further comprises heating the proppant particles to between 700° C. and 1300° C. and cooling the proppant particles to below 700° C.

4. The method of claim 3, wherein heating the proppant particles includes heating the proppant particles to between 700° C. and 1100° C. and cooling the proppant particles to below 700° C.

5. The method of claim 3, wherein heating the proppant particles comprises heating the proppant particles from a temperature of less than 700° C.

6. (canceled)

7. The method of claim 1, wherein the droplets are partially solidified prior to maintaining the droplets at a temperature between 700° C. and 1300° C.

8. (canceled)

9. The method of claim 1, wherein the droplets are completely solidified prior to maintaining the droplets at a temperature between 700° C. and 1300° C.

10. The method of claim 1, wherein the molten slag material comprises a material selected from aluminum oxide, barium oxide, boron oxide, calcium oxide, chromium oxide, iron oxide, magnesium oxide, manganese oxide, phosphorous oxide, potassium oxide, silicon oxide, sodium oxide, sulfur oxide, strontium oxide, titanium oxide, vanadium oxide, zirconium oxide, mixtures thereof, and compounds thereof.

11. The method of claim 1, further comprising adding a nucleating agent to the molten slag material.

12. The method of claim 11, wherein the nucleating agent includes titanium, zirconium, barium, aluminum, strontium, vanadium, phosphorus, fluorine, or combinations thereof.

13. The method of claim 11, wherein the nucleating agent includes titanium, barium, zirconium, or combinations thereof.

14. The method of claim 1, wherein the molten slag material includes one or more additives, wherein the one or more additives include aluminum, beryllium, boron, calcium, carbon, chromium, iron, lithium, magnesium, manganese, nitrogen, oxygen, phosphorous, potassium, silicon, sodium, sulfur, titanium, yttrium (ΓΠ) oxide, zirconium, aluminum dross, volcanic ash, and mixtures thereof.

15. (canceled)

16. The method of claim 1, wherein the proppant particles comprise from greater than 0% to 90% by weight crystalline phase.

17. The method of claim 16, wherein the proppant particles comprise from 30% to 90% by weight crystalline phase.

18. The method of claim 1, wherein the method produces a Type I failure of the proppant particles that is at least 10% greater than the Type I failure of proppant particles that do not include a crystalline phase.

19. The method of claim 1, wherein the method produces proppant particles that have a ratio of Type I failure to Type II failure that is at least 10% greater than the ratio of Type I failure to Type II failure for proppant particles that do not include a crystalline phase.

20. The method of claim 1, wherein when the proppants are subjected to a crush test described by ISO 13503-2: 2006/API RO19C:2008, at least 50% of the resulting particles by weight have a diameter of 35% or greater of the original proppant diameter.

21. (canceled)

22. The method of claim 1, wherein the proppants have an average diameter of from 850 μm to 1 mm and when the proppants are subjected to the crush test described by ISO 13503-2: 2006/API RO19C:2008, at least 50% of the resulting particles by weight have a diameter of greater than 300 μm.

23. A proppant particle prepared by the method according to claim 1.

24. A method for hydraulic fracturing of a well in a subterranean formation having a fracturing stress, comprising pumping a fracturing fluid comprising the proppant particles of claim 23 into the well at a pressure above the fracturing stress of the formation to carry the proppant particles in the fluid into the subterranean formation.
